(19) United States
(12) Patent Application Publication
(10) Pub. No.: US 2007/0051574 A1
(43) Pub. Date: Mar. 8, 2007

(54) Rod guide seal

(75) Inventors: Daniel T. Keil, Temperance, MI (US); Matthew Roessle, Temperance, MI (US); Lonnie Miller, Monroe, MI (US)

Correspondence Address: HARNESS, DICKEY & PIERCE, P.L.C., P.O. BOX 828, BLOOMFIELD HILLS, MI, 48303, US

(73) Assignee: Tenneco Automotive Operating Company, Inc., Lake Forest, IL (US)

(21) Appl. No.: 11/218,380

(22) Filed: Sep. 2, 2005

(51) Int. Cl. F16F 9/36

(52) U.S. Cl. 188/322.18

(57) ABSTRACT

A shock absorber includes a rod guide assembly which includes a pair of bearings spaced from each other and a seal assembly located adjacent one of the two bearings. The seal assembly can be located between the two bearings or the seal assembly can be located adjacent one of the two bearings but not between them.

### FIELD OF THE INVENTION

The present invention relates to shock absorbers. More particularly, the present invention relates to a sealing system for the rod guide assembly of the shock absorber which includes additional support for the piston rod by the rod guide assembly.

### BACKGROUND OF THE INVENTION

Shock absorbers are used in conjunction with automobile suspension systems and other vehicle suspension systems to absorb unwanted vibrations which occur during operation of the vehicle. To absorb this unwanted vibrations, shock absorbers are connected between the sprung mass (the body) and the unsprung mass (the suspension system) of the vehicle. A monotube shock absorber has a piston which is located within a pressure tube of the shock absorber and the piston is typically connected to the sprung mass of the vehicle using a piston rod. The pressure tube is typically connected to the unsprung mass of the vehicle and it is typically filled with hydraulic fluid. The piston includes valving systems which have the capability to limit the flow of hydraulic fluid within the pressure tube when the shock absorber is compressed (compression stroke) or extended (rebound stroke). The limiting of fluid flow produces a damping force which counteracts the vibrations which would otherwise be transmitted from the suspension (unsprung mass) to the body (sprung mass) of the vehicle.

A dual tube shock absorber comprises a pressure tube with a piston disposed therein and a reserve tube surrounding the pressure tube. The piston divides the pressure tube into an upper working chamber and a lower working chamber. A piston rod is connected to the piston and the piston rod extends through the upper working chamber of the pressure tube and through the upper end of the reserve tubes. At the lower end of the pressure tube, a base valve assembly is located between the pressure tube and the reserve tube. The base valve assembly controls fluid flow between the working chamber defined by the pressure tube and a reserve chamber defined by the reserve tube. Due to the piston rod being located on only one side of the piston within the upper working chamber, a different amount of fluid is displaced between the upper working chamber above the piston and the lower working chamber below the piston when the shock absorber extends or compresses. This difference in the amount of fluid is termed the “rod volume”. During a compression stroke, the “rod volume” flows out of the lower working chamber through the base valve assembly and into the reserve chamber. During a rebound or extension stroke, the “rod volume” flows out of the reserve chamber through the base valve assembly and into the lower working chamber. The piston rod is typically connected to the unsprung mass of the vehicle and the reserve tube is typically secured to the unsprung mass of the vehicle. During an extension or rebound stroke, a valving system in the piston limits the flow of hydraulic fluid within the pressure tube to produce a damping force. A check valve is included in the base valve assembly to accommodate the “rod volume” flow of fluid. During a compression stroke, a valving system in the base valve assembly limits the flow of hydraulic fluid between the lower working chamber and the reserve chamber to produce a damping force. A check valve is included in the piston to allow fluid to flow into the upper working chamber.

The piston rod of a shock absorber is supported at its lower end by the piston and it is slidingly received at the upper end of the pressure tube, and the reserve tube for a dual tube shock absorber, by a rod guide assembly. The rod guide assembly thus functions as a slide bearing for the piston rod. The rod guide assembly properly positions the piston rod within the pressure tube and also acts as a closure member for both the pressure tube and the reserve tube when the reserve tube is present. In order for the smooth sliding of the piston rod through the rod guide assembly, a slight clearance is formed between the inner periphery of the bearing portion of the rod guide assembly and the outer surface of the piston rod. This slight clearance allows for the hydraulic fluid to lubricate the interface between the piston rod and the rod guide assembly.

In addition to locating the piston rod and closing the pressure tube and the reserve tube when present, the rod guide assembly supports and locates a seal assembly which is designed to keep the hydraulic fluid within the shock absorber and also keep contaminants out of the shock absorber. The seal assembly normally interfaces between the rod guide assembly and the piston rod and its purpose is to seal this interface in both rebound and compression strokes.

The prior art seal assemblies function well but when the shock absorber is subjected to excessive side-loads, deflection of the piston rod under these excessive side-loads has presented problems to the prior art seal assemblies. These problems have included seal leakage due to excessive wear, excessive contact stresses and even the possibility of piston rod scoring.

### SUMMARY OF THE INVENTION

The present invention provides the art with a rod guide assembly which increases the bearing area contact between the piston rod and the bearing portion of the rod guide assembly. Increasing the bearing area contact between these components results in a decrease in the contact stress between these two components thus reducing the wear on the bearing portion of the rod guide assembly and on the piston rod. In addition, piston rod deflection is reduced which in turn reduces the deflection of the seal assembly. Limiting the deflection of the seal assembly will reduce the contact stress between the seal assembly and the piston rod reducing wear of the seal assembly.

Another advantage of the present invention is that the stress on the piston post of the piston rod is reduced. Piston rod side-load causes loading of the piston rod against the rod guide assembly as well as loading of the piston post which is used to attach the piston assembly which is slidingly received within the pressure tube of the shock absorber. The piston post which is utilized for the attachment of damper valving in the piston assembly is a critical structure area for shock absorbers, particularly shock absorbers used with struts of spring over shock absorber designs. One method of attachment for the piston assembly utilizes a reduced diameter and thus a reduced cross-sectional area on the piston rod that is threaded for fastener attachment of the damper valving and piston assembly. As such, the cross-sectional area of the piston post has a smaller cross-sectional area than the rest of the piston rod. In addition, it has a stress concentration factor attributed to the relatively sharp corner at the base of the piston post. Therefore, this is typically a highly stressed portion of the piston rod. Reducing the contact stress at the bearing portion of the rod guide assembly reduces the stress loading at the piston post thus increasing the durability of the piston post and the piston rod.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an illustration of an automobile using the rod guide seal in accordance with the present invention;

FIG. 2 is a cross-sectional view of a dual tube shock absorber shown in FIG. 1 incorporating the rod guide seal in accordance with the present invention;

FIG. 3 is an enlarged cross-sectional view of the rod guide assembly for the shock absorber shown in FIG. 2;

FIG. 4 is an enlarged cross-sectional view of a rod guide assembly in accordance with another embodiment of the present invention;

FIG. 5 is an enlarged cross-sectional view of a rod guide assembly in accordance with another embodiment of the present invention;

FIG. 6 is an enlarged cross-sectional view of a rod guide assembly in accordance with another embodiment of the present invention; and,

FIG. 7 is a cross-sectional view of a mono-tube shock absorber incorporating the rod guide assembly illustrated in FIG. 4.

### DETAILED DESCRIPTION OF THE PREFERRED EMBODIMENTS

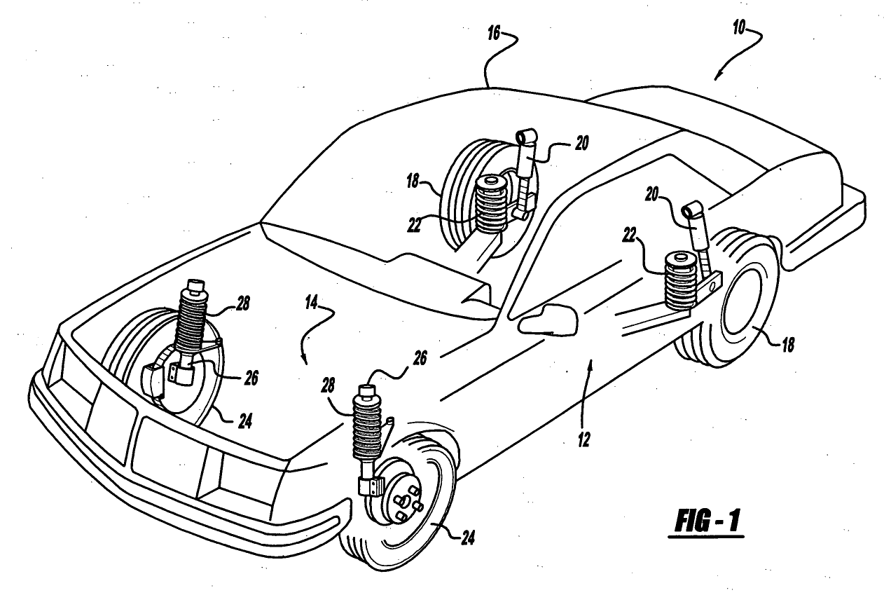

The following description of the preferred embodiment(s) is merely exemplary in nature and is in no way intended to limit the invention, its application, or uses. Referring now to the drawings in which like reference numerals designate like or corresponding parts throughout the several views, there is shown in FIG. 1, a vehicle incorporating shock absorbers which include the rod guide assembly in accordance with the present invention and which is designated generally by the reference numeral 10. Vehicle 10 includes a rear suspension system 12, a front suspension 14 and a body 16. Rear suspension system 12 includes a pair of rear suspension arms adapted to operatively support a pair of rear wheels 18. Each rear suspension arm is attached to body 16 by means of a shock absorber 20 and a helical coil spring 22. Similarly, front suspension system 14 includes a pair of suspension arms adapted to operatively support a pair of front wheels 24. Each suspension arm is attached to body 16 by means of a shock absorber 26 and a helical coil spring 28. Rear shock absorbers 20 and front shock absorbers 26 serve to dampen the relative movement of the unsprung portion of vehicle 10 (i.e., front and rear suspension systems 12, 14) with respect to the sprung portion (i.e., body 16) of vehicle 10. While vehicle 10 has been depicted as a passenger vehicle having independent front and rear suspension 12 and 14, shock absorbers 20 and 26 may be used with other types of vehicles having other types of suspension and springs or in other types of applications including, but not limited to, vehicles incorporating air springs, leaf springs, non-independent front and/or non-independent rear suspension systems. Further, the term “shock absorber” as used herein is meant to refer to dampers in general and thus will include MacPherson struts, spring seat units as well as other shock absorber designs known in the art.

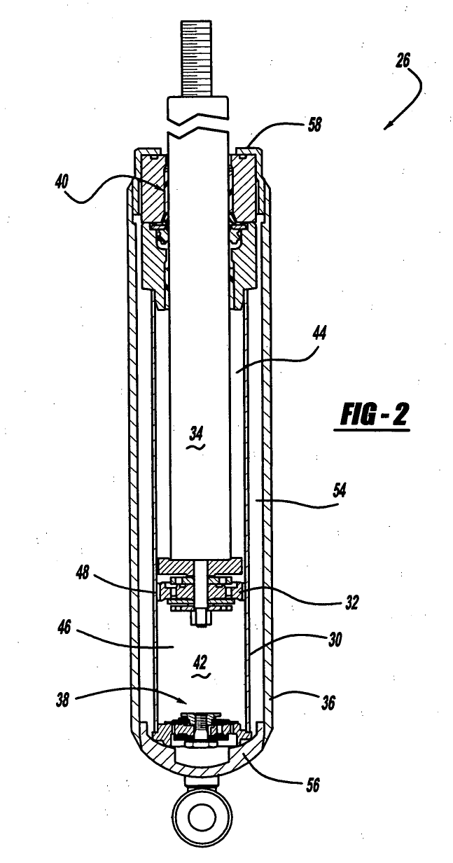

Referring now to FIG. 2, front shock absorber 26 is shown in greater detail. While FIG. 2 shows only front shock absorber 26, it is to be understood that rear shock absorber 20 is also designed to include the rod guide assembly in accordance with the present invention. Rear shock absorber 20 only differs from front shock absorber 26 in the way it is adapted to be connected to the sprung and unsprung portions of vehicle 10. Shock absorber 26 comprises a pressure tube 30, a piston assembly 32, a piston rod 34, a reserve tube 36, a base valve assembly 38 and a rod guide assembly 40.

Pressure tube 30 defines a working chamber 42. Piston assembly 32 is slidably disposed within pressure tube 30 and divides working chamber 42 into an upper working chamber 44 and a lower working chamber 46. A seal 48 is disposed between piston assembly 32 and pressure tube 30 to permit sliding movement of piston assembly 32 with respect to pressure tube 30 without generating undue frictional forces as well as sealing upper working chamber 44 from lower working chamber 46. Piston rod 34 is attached to piston assembly 32 and extends through upper working chamber 44 and through rod guide assembly 40 which closes the upper end of both pressure tube 30 and reserve tube 36. The end of piston rod 34 opposite to piston assembly 32 is adapted to be secured to the sprung portion of vehicle 10. Valving within piston assembly 32 controls the movement of fluid between upper working chamber 44 and lower working chamber 46 during movement of piston assembly 32 within pressure tube 30. Because piston rod 34 extends only through upper working chamber 44 and not lower working chamber 46, movement of piston assembly 32 with respect to pressure tube 30 causes a difference in the amount of fluid displaced in upper working chamber 44 when compared with the amount of fluid displaced in lower working chamber 46. This difference in the amount of fluid displaced is termed the “rod volume” and it flows through base valve assembly 38.

Reserve tube 36 surrounds pressure tube 30 to define a reserve chamber 54 located between the tubes. The bottom end of reserve tube 36 is closed by an end cap 56. Either end cap 56 or reserve tube 36 is adapted to be connected to the unsprung portion of vehicle 10. The upper end of reserve tube 36 is attached to rod guide assembly 40 by mechanically deforming the open end of reserve tube 36 to form a retaining flange 58 or by other means known in the art. Base valve assembly 38 is disposed between lower working chamber 46 and reserve chamber 54 to control the flow of fluid, the “rod volume” of fluid between the two chambers. When shock absorber 26 extends in length (rebound), an additional amount of fluid, the “rod volume”, is needed in lower working chamber 46. Thus, fluid will flow from reserve chamber 54 to lower working chamber 46 through base valve assembly 38. When shock absorber 26 shortens in length (compression), excess fluid, the “rod volume”, must be removed from lower working chamber 46. Thus, fluid will flow from lower working chamber 46 to reserve chamber 54 through base valve assembly 38.

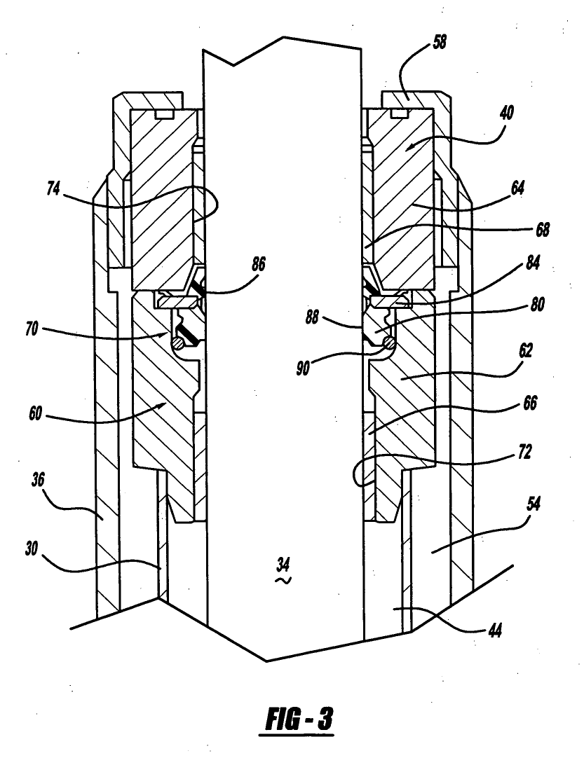

Referring now to FIGS. 2 and 3, rod guide assembly 40 is illustrated in greater detail. Rod guide assembly 40 comprises a housing assembly 60 including a lower bearing housing 62, an upper bearing housing 64, a lower bearing 66, an upper bearing 68 and a seal assembly 70.

Lower bearing housing 62 is assembled to pressure tube 30 using a press fit relationship or by any other means known in the art. Upper bearing housing 64 abuts lower bearing housing 62. Reserve tube 36 is assembled to upper bearing housing 64 by a press fit relationship or by any other means known in the art. Reserve tube 36 is deformed at its open end to form retaining flange 58 to engage top of upper bearing housing 64 to retain the assembly of shock absorber 26.

Lower bearing 66 is disposed between lower bearing housing 62 and piston rod 34. Lower bearing 66 is press fit within a counterbore 72 formed into lower bearing housing 62 or secured to lower bearing housing 62 by any other means known in the art. Upper bearing 68 is disposed between upper bearing housing 64 and piston rod 34. Upper bearing 68 is press fit within a counterbore 74 formed into upper bearing housing 64 or by any other means known in the art.

Seal assembly 70 comprises an elastomeric member 80 having a metal retainer 84 molded into elastomeric member 80. Elastomeric member 80 includes a pair of sealing lips 86 and 88 each of which engage piston rod 34. A retaining spring 90 urges sealing lip 88 into engagement with piston rod 34.

By incorporating lower bearing 66 at one side of seal assembly 70 and upper bearing 68 at the other side of seal assembly 70, numerous enhancements to the durability of shock absorber 26 are realized. These enhancements include but are not limited to the following.

Deflection of piston rod 34 due to side loading of shock absorber 26 is reduced due to the increased length of the support for piston rod 34 by lower bearing 66 and upper bearing 68. Reducing the deflection of piston rod 34 in turn reduces the deflection of seal assembly 70. Limiting the deflection of seal assembly 70 reduces the contact stresses between seal assembly 70 and piston rod 34 and thus reduces the seal lip wear of the seal assembly 70.

The increase in the bearing area between piston rod 34 and lower and upper bearings 66 and 68 results in a decrease in contact stress between these components and thus a reduction in the wear of lower and upper bearings 66 and 68 and of piston rod 34.

Due to the increased bearing area provided by lower and upper bearings 66 and 68, the side load to the piston rod is reduced. This reduces the side load which acts at the piston post of piston rod 34 to which piston assembly 32 is attached. The piston post of piston rod 34 which is utilized for the attachment of piston assembly 32 is a critical structural area particularly for struts and spring over shocks. The piston post of piston rod 34 is a reduced diameter portion of piston rod 34 and thus a reduced cross sectional area of piston rod 34 that is threaded and is used with a fastener for the attachment of piston assembly 32. In addition to the reduced cross sectional area, a stress concentration factor can be attributed to the relative sharp corner where the piston post meets the main body of piston rod 34. Therefore, this is a highly stressed section of piston rod 34. Reducing the side loads of the piston post will therefore increase the durability of the piston post of piston rod 34.

In some applications where piston rod deflections are large and thus the stresses on the piston post are excessive, incorporation of rod guide assembly 40 can be used instead of increasing the diameter of piston rod 34 to accommodate the high loading.

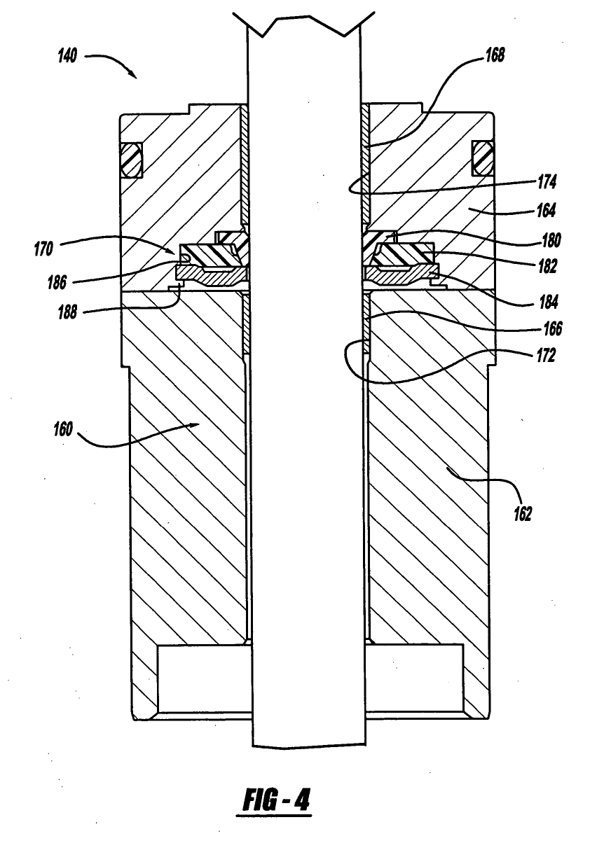

Referring now to FIG. 4, a rod guide assembly 140 in accordance with another embodiment of the present invention is illustrated. Rod guide assembly 140 is a direct replacement for and thus interchangeable with rod guide assembly 40. Rod guide assembly 140 comprises a housing assembly 160 including a lower bearing housing 162, an upper bearing housing 164, a lower bearing 166, an upper bearing 168 and a seal assembly 170.

Lower bearing housing 162 is adapted to be press fit to pressure tube 30 or to be attached to pressure tube 30 by any means known in the art. Upper bearing housing 164 abuts lower bearing housing 162. Upper bearing housing 164 is adapted to be press fit with reserve tube 36 or to be attached to reserve tube 36 by any means known in the art. As illustrated for rod guide assembly 40, reserve tube 36 can be deformed at its top end to engage the top of upper bearing housing 164 to retain the assembly of the shock absorber.

Lower bearing 166 is disposed between lower bearing housing 162 and piston rod 34. Lower bearing 166 is press fit within a bore 172 formed in lower bearing housing 162 or secured to lower bearing housing 162 by any other means known in the art. Upper bearing 168 is disposed between upper bearing housing 164 and piston rod 34. Upper bearing 168 is press fit within a bore 174 formed into upper bearing housing 164 or secured to upper bearing housing 164 by any other means known in the art.

Seal assembly 170 is disposed between piston rod 34, lower bearing housing 162 and upper bearing housing 164. Seal assembly 170 comprises an upper elastomeric seal 180, a lower elastomeric seal 182 and a retainer 184. Upper elastomeric seal 180 is disposed in a stepped counterbore 186 between upper bearing housing 164 and piston rod 34. Lower elastomeric seal 182 is disposed in stepped counterbore 186 between upper elastomeric seal 180 and upper bearing housing 164. Lower elastomeric seal 182 urges upper elastomeric seal 180 into engagement with piston rod 34. Retainer 184 is disposed in stepped counterbore 186 in order to retain both lower and upper elastomeric seals 180 and 182. The open end of stepped counterbore 186 is crimped over as shown at 188 to retain seal assembly 170 within stepped counterbore 186 formed in upper bearing housing 164.

By incorporating lower bearing 166 at one side of seal assembly 170 and upper bearing 168 at the other side of seal assembly 170, numerous enhancements to the durability of shock absorber 26 are realized. These enhancements include but are not limited to the enhancements described above for rod guide assembly 40.

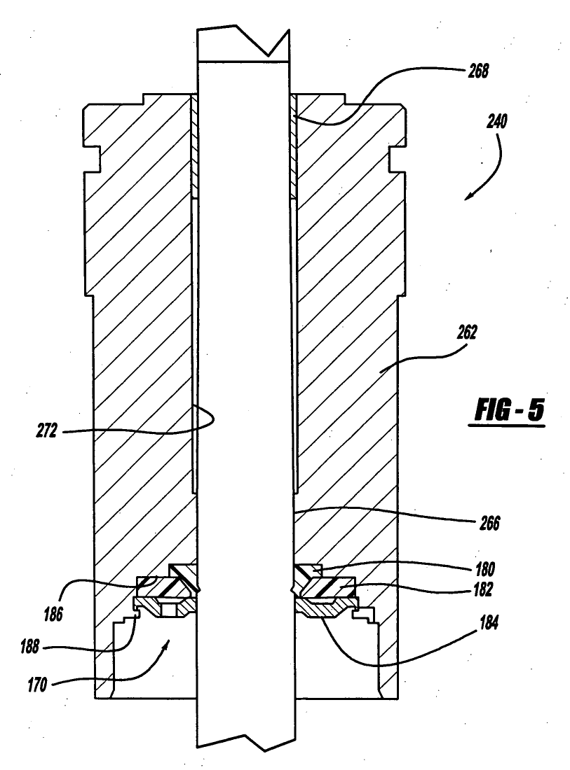

Referring now to FIG. 5, a rod guide assembly 240 in accordance with another embodiment of the present invention is illustrated. Rod guide assembly 240 is a direct replacement for and thus interchangeable with rod guide assembly 40. Rod guide assembly 240 comprises a bearing housing 262, a lower bearing 266, an upper bearing 268 and seal assembly 170.

Bearing housing 262 is a single piece component which is adapted to be press fit to pressure tube 30 or to be attached to pressure tube 30 by any means known in the art. Bearing housing 262 is also adapted to be press fit with reserve tube 36 or to be attached to reserve tube 36 by any means known in the art. As illustrated for rod guide assembly 40, reserve tube 36 can be deformed at its top end to engage the top of bearing housing 262 to retain the assembly of the shock absorber.

Lower bearing 266 is disposed between bearing housing 262 and piston rod 34. Lower bearing 266 is integral with bearing housing 262 or it can be a separate component which is press fit within a bore 272 formed in bearing housing 262 or secured to bearing housing 262 by any other means known in the art. Upper bearing 268 is disposed between bearing housing 262 and piston rod 34. Upper bearing 268 is press fit within bore 272 formed into bearing housing 262 or secured to bearing housing 262 by any other means known in the art.

Seal assembly 170 is disposed between piston rod 34, bearing housing 262. Seal assembly 170 comprises upper elastomeric seal 180, lower elastomeric seal 182 and retainer 184. Upper elastomeric seal 180 is disposed in a stepped counterbore 186 between bearing housing 262 and piston rod 34. Lower elastomeric seal 182 is disposed in stepped counterbore 186 between upper elastomeric seal 180 and bearing housing 262. Lower elastomeric seal 182 urges upper elastomeric seal 180 into engagement with piston rod 34. Retainer 184 is disposed in stepped counterbore 186 in order to retain both lower and upper elastomeric seals 180 and 182. The open end of stepped counterbore 186 is crimped over as shown at 188 to retain seal assembly 170 within stepped counterbore 186 formed in bearing housing 262.

By incorporating lower bearing 266 and upper bearing 268 on the same side of seal assembly 170 but spaced from each other, numerous enhancements to the durability of shock absorber 26 are realized. These enhancements include but are not limited to the enhancements described above for rod guide assembly 40. In addition, by incorporating lower bearing 266 and upper bearing 268 on the same side or seal assembly 170, bearing housing 260 can be a single piece integral component.

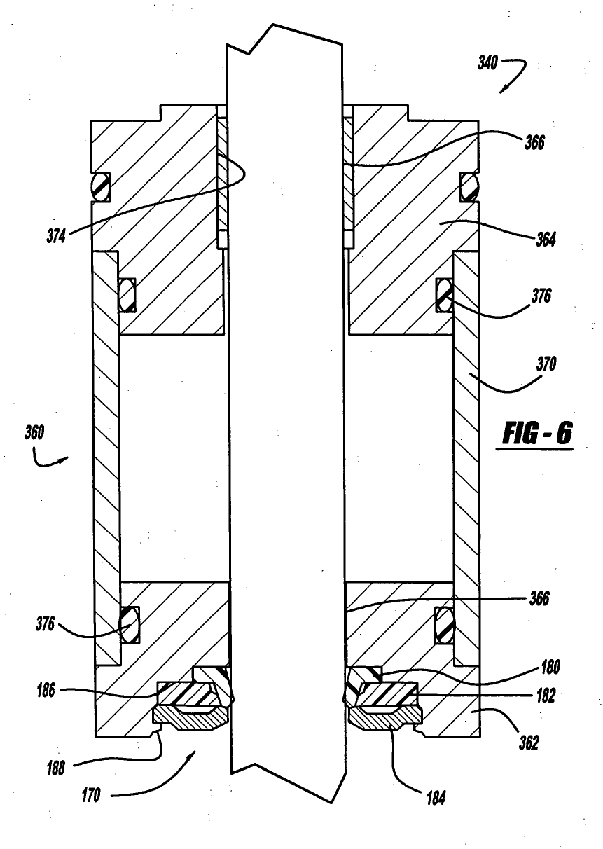

Referring now to FIG. 6, a rod guide assembly 340 in accordance with another embodiment of the present invention is illustrated. Rod guide assembly 340 is a direct replacement for and thus interchangeable with rod guide assembly 40. Rod guide assembly 340 comprises a housing assembly 360 including a lower bearing housing 362, an upper bearing housing 364, a lower bearing 366, an upper bearing 368 and seal assembly 170.

Lower bearing housing 362 is adapted to be press fit to pressure tube 30 or to be attached to pressure tube 30 by any means known in the art. Upper bearing housing 364 is spaced from lower bearing housing 362 by a tube 370. Upper bearing housing 364 is adapted to be press fit with reserve tube 36 or to be attached to reserve tube 36 by any means known in the art. As illustrated for rod guide assembly 40, reserve tube 36 can be deformed at its top end to engage the top of upper bearing housing 364 to retain the assembly of the shock absorber.

Lower bearing 366 is disposed between lower bearing housing 362 and piston rod 34. Lower bearing 366 is integral with lower bearing housing 362 or it can be a separate component which is press fit within a bore (not shown) formed in lower bearing housing 362 or secured to lower bearing housing 362 by any other means known in the art. Upper bearing 368 is disposed between upper bearing housing 364 and piston rod 34. Upper bearing 368 is press fit within a bore 374 formed into upper bearing housing 364 or secured to upper bearing housing 364 by any other means known in the art.

Seal assembly 170 is disposed between piston rod 34, lower bearing housing 362. Seal assembly 170 comprises upper elastomeric seal 180, lower elastomeric seal 182 and retainer 184. Upper elastomeric seal 180 is disposed in a stepped counterbore 186 between lower bearing housing 362 and piston rod 34. Lower elastomeric seal 182 is disposed in stepped counterbore 186 between upper elastomeric seal 180 and lower bearing housing 362. Lower elastomeric seal 182 urges upper elastomeric seal 180 into engagement with piston rod 34. Retainer 184 is disposed in stepped counterbore 186 in order to retain both lower and upper elastomeric seals 180 and 182. The open end of stepped counterbore 186 is crimped over as shown at 188 to retain seal assembly 170 within stepped counterbore 186 formed in lower bearing housing 362.

By incorporating lower bearing 366 and upper bearing 368 on the same side of seal assembly 170 but spaced from each other, numerous enhancements to the durability of shock absorber 26 are realized. These enhancements include but are not limited to the enhancements described above for rod guide assembly 40.

In addition, the utilization of tube 370 to space upper bearing housing 364 from lower bearing housing 362 simplifies the machining of bearing housings 362 and 364 by reducing the lengths of the bore for lower bearing 366 if present and bore 374 and it reduces the weight of the lower and upper bearing housings when compared with the other embodiments. A pair of seals 376 seal the interface between lower and upper bearing housings 362 and 364 and tube 370.

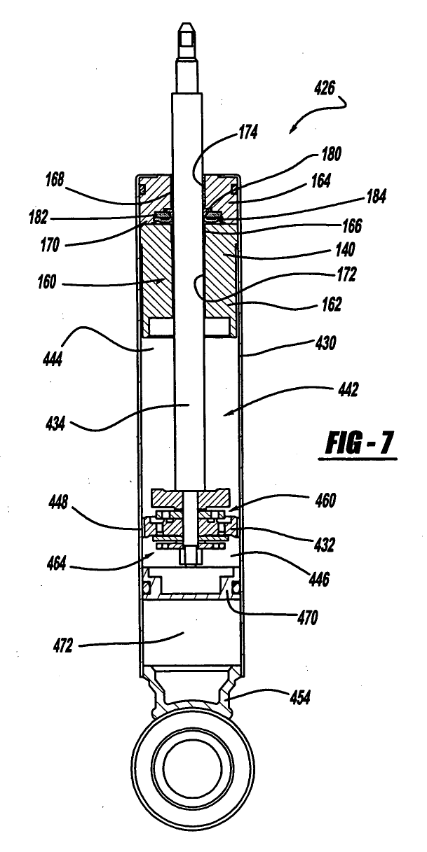

Referring now to FIG. 7, a shock absorber 426 in accordance with the present invention is illustrated. Shock absorber 426 can replace either shock absorber 20 or shock absorber 26 by modifying the way that it is adapted to be connected to the sprung mass and/or the unsprung mass of vehicle 10. Shock absorber 426 comprises a pressure tube 430, a piston assembly 432, a piston rod 434 and rod guide assembly 140.

Pressure tube 430 defines a working chamber 442. Piston assembly 432 is slidably disposed within pressure tube 430 and divides working chamber 442 into an upper working chamber 444 and a lower working chamber 446. A seal 448 is disposed between piston assembly 432 and pressure tube 430 to permit sliding movement of piston assembly 432 with respect to pressure tube 430 without generating undue frictional forces as well as sealing upper working chamber 444 from lower working chamber 446. Piston rod 434 is attached to piston assembly 432 and it extends through upper working chamber 444 and through rod guide assembly 140 which closes the upper end of pressure tube 430. The end of piston rod 434 opposite to piston assembly 432 is adapted to be secured to the sprung mass of vehicle 10. The end of pressure tube 430 opposite to rod guide assembly 140 is closed by a base cup 454 which is adapted to be connected to the unsprung mass of vehicle 10.

A compression valve assembly 460 associated with piston assembly 432 controls movement of fluid between lower working chamber 446 and upper working chamber 444 during compression movement of piston assembly 432 within pressure tube 430. The design for compression valve assembly 460 controls the damping characteristics for shock absorber 410 during a compression stroke. An extension valve assembly 464 associated with piston assembly 432 controls movement of fluid between upper working chamber 444 and lower working chamber 446 during extension or rebound movement of piston assembly 432 within pressure tube 430. The design for extension valve assembly 464 controls the damping characteristics for shock absorber 410 during an extension or rebound stroke.

Because piston rod 434 extends only through upper working chamber 444 and not lower working chamber 446, movement of piston assembly 432 with respect to pressure tube 430 causes a difference in the amount of fluid displaced in upper working chamber 444 and the amount of fluid displaced in lower working chamber 446. The difference in the amount of fluid displaced is known as the “rod volume” and compensation for this fluid is accommodated by a piston 470 slidably disposed within pressure tube 430 and located between lower working chamber 446 and a compensation chamber 472. Typically compensation chamber 472 is filled with a pressurized gas and piston 470 moves within pressure tube 430 to compensate for the rod volume concept.

Referring now to FIG. 7, rod guide assembly 140 is illustrated. Rod guide assembly 140 is a direct replacement for and thus interchangeable with rod guide assembly 40, 240 and 340. Rod guide assembly 140 comprises a housing assembly 160 including lower bearing housing 162, upper bearing-housing 164, lower bearing 166, upper bearing 168 and seal assembly 170.

Lower bearing housing 162 is adapted to be press fit to pressure tube 430 or to be attached to pressure tube 30 by any means known in the art. Upper bearing housing 164 abuts lower bearing housing 162. Upper bearing housing 164 is also adapted to be press fit with pressure tube 430 or to be attached to pressure tube 430 by any means known in the art. As illustrated in FIG. 7, pressure tube 430 can be deformed at its top end to engage the top of upper bearing housing 164 to retain the assembly of the shock absorber.

Lower bearing 166 is disposed between lower bearing housing 162 and piston rod 434. Lower bearing 166 is press fit within a bore 172 formed in lower bearing housing 162 or secured to lower bearing housing 162 by any other means known in the art. Upper bearing 168 is disposed between upper bearing housing 164 and piston rod 434. Upper bearing 168 is press fit within a bore 174 formed into upper bearing housing 164 or secured to upper bearing housing 164 by another means known in the art.

Seal assembly 170 is disposed between piston rod 434, lower bearing housing 162 and upper bearing housing 164. Seal assembly 170 comprises an upper elastomeric seal 180, a lower elastomeric seal 182 and a retainer 184. Upper elastomeric seal 180 is disposed in a stepped counterbore 186 between upper bearing housing 164 and piston rod 434. Lower elastomeric seal 182 is disposed in stepped counterbore 186 between upper elastomeric seal 180 and upper bearing housing 164. Lower elastomeric seal 182 urges upper elastomeric seal 180 into engagement with piston rod 434. Retainer 184 is disposed in stepped counterbore 186 in order to retain both lower and upper elastomeric seals 180 and 182. The open end of stepped counterbore 186 is crimped over as shown at 188 to retain seal assembly 170 within stepped counterbore 186 formed in upper bearing housing 164.

By incorporating lower bearing 166 at one side of seal assembly 170 and upper bearing 168 at the other side of seal assembly 170, numerous enhancements to the durability of shock absorber 426 are realized. These enhancements include but are not limited to the enhancements described above for rod guide assembly 40.

While shock absorber 476 is illustrated incorporating rod guide assembly 140, it is within the scope of the present invention to incorporate rod guide assembly 40, 240 or 340 into shock absorber 426 if desired.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A shock absorber comprising:
a pressure tube;
a piston assembly slidably disposed within the pressure tube;
a piston rod attached to the piston assembly and extending out one end of the pressure tube;
a rod guide assembly disposed between the pressure tube and the piston rod, the rod guide assembly comprising:
a housing assembly disposed between the pressure tube and the piston rod;
a first bearing disposed between the housing assembly and the piston rod;
a second bearing disposed between the housing assembly and the piston rod, the second bearing being spaced from the first bearing;
a seal assembly disposed between the housing assembly and the piston rod.

2. The shock absorber according to claim 1, wherein the housing assembly comprises a first housing and a second housing, the first bearing being disposed in the first housing, the second bearing being disposed in the second housing.

3. The shock absorber according to claim 2, wherein the seal assembly is disposed between the first and second housings.

4. The shock absorber according to claim 1, wherein the seal assembly is disposed between the first and second bearing.

5. The shock absorber according to claim 1, wherein the shock absorber further comprises a reserve tube, the rod guide assembly being connected to said pressure tube and said reserve tube.

6. The shock absorber according to claim 1, wherein said seal assembly is disposed adjacent one of said first and second bearings.

7. The shock absorber according to claim 1, wherein said seal assembly is not disposed between said first and second bearings.

8. The shock absorber according to claim 1, wherein the housing assembly comprises:
a first housing for locating said first bearing;
a second housing for locating said second bearing; and
a tube disposed between said first and second housings.

9. The shock absorber according to claim 8, wherein said seal assembly is disposed adjacent one of said first and second bearings.

10. The shock absorber according to claim 8, wherein said seal assembly is not disposed between said first and second bearings.

11. The shock absorber according to claim 1, wherein the housing assembly is an internal single piece component.

12. The shock absorber according to claim 11, wherein said seal assembly is disposed adjacent one of said first and second bearings.

13. The shock absorber according to claim 11, wherein said seal assembly is not disposed between said first and second bearings.
